(19) United States
(12) Patent Application Publication
(10) Pub. No.: US 2007/0002844 A1
(43) Pub. Date: Jan. 4, 2007

(54) Internetworking IP and cellular networks

(76) Inventor: Rashad Mohammad Ali, Plano, TX (US)

Correspondence Address: FISH & RICHARDSON P.C., P.O. BOX 1022, MINNEAPOLIS, MN, 55440-1022, US

(21) Appl. No.: 11/477,057

(22) Filed: Jun. 28, 2006

Related U.S. Application Data
(60) Provisional application No. 60/694,906, filed on Jun. 28, 2005.

(51) Int. Cl. H04L 12/66

(52) U.S. Cl. 370/352

(57) ABSTRACT

The disclosure provides a system and method for internetworking IP and cellular networks. In one aspect, embedded wireless network intelligence may be used to service IP and/or IP connected communication devices. The communication devices may be session initiation protocol (SIP) devices. Thus, native SIP devices may be serviced by wireless network devices. The wireless services may comprise location, handoff and/or other servicing provided by wireless protocol methods.

### TECHNICAL FIELD

This invention relates to networks, and more particularly to internetworking Internet Protocol (IP) and cellular networks.

### BACKGROUND

Communication networks include wired and wireless networks. Example wired call networks Public Switch Telephone Network (PSTN) and the Internet. Example wireless networks include Global System for Mobile Communication (GSM) and Code Division Multiple Access (CDMA), and others. Calls may be connected across wired and wireless networks between the PSTN.

### SUMMARY

The disclosure provides a system and method for internetworking IP and cellular networks. In one aspect, embedded wireless network intelligence may be used to service IP and/or IP connected communication devices. The communication devices may be session initiation protocol (SIP) devices. Thus, native SIP devices may be serviced by wireless network devices. The wireless services may comprise location, handoff and/or other servicing provided by wireless protocol methods.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a communication system in accordance with one embodiment of the present disclosure;

FIGS. 2A-D illustrate example protocol stacks in accordance with communication system of FIG. 1;

FIGS. 3A-H illustrates example call flows in accordance with communication system of FIG. 1;

FIG. 4 is a communication system in accordance with another embodiment of the present disclosure;

FIGS. 5A and 5B illustrates modules for gateway of the communication system in FIG. 4;

FIGS. 6A and 6B is one embodiment of communication system of FIG. 4;

FIGS. 7A and 7B is another embodiment of communication system of FIG. 4;

FIGS. 8A and 8B is yet another embodiment of communication system of FIG. 4;

FIGS. 9A and 9B illustrate example call flows in accordance with communication system of FIGS. 8A and 8B; and

FIG. 10 illustrates a method for establishing a call session in accordance with one embodiment of the present disclosure.

Like reference symbols in the various drawings indicate like elements.

### DETAILED DESCRIPTION

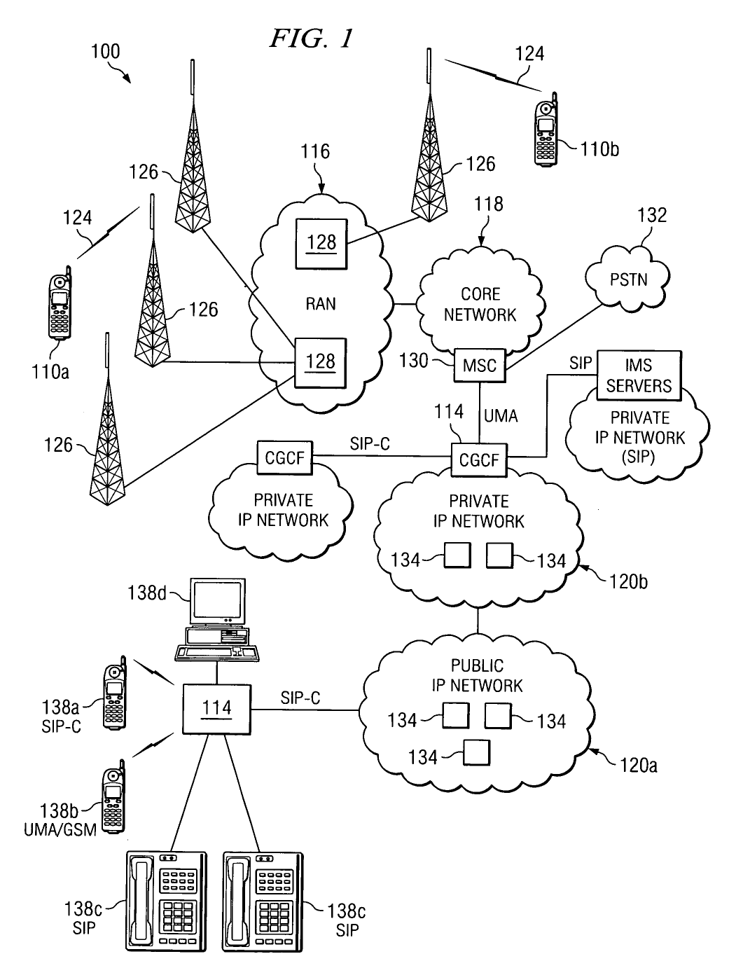

FIG. 1 illustrates a communication system 100 for communicating wireless protocols through an Internet Protocol (IP) network 120. In this embodiment, system 100 includes a radio access network (RAN) 116 in which wireless transmissions originate in geographically delineated cells. During transmission, system 100 uses wireless protocols such as Global System for Mobile Communication (GSM) protocols, Code Division Multiple Access (CDMA) protocols, Universal Mobile Telecommunications System (UMTS), Unlicensed Mobile Access (UMA), or any other suitable protocol for formatting data for wireless communication with a network element. In some embodiments, system 100 provides a unified protocol approach to support voice and multimedia that enables a call session to maintain wireless services across IP network 120. System 100 converts wireless-protocol messages into IP messages for tunneling wireless services through IP network 120 to telephony devices 138 and, thus, providing a framework for the integration of cellular telephony signaling into IP messages. In one embodiment, system 100 converts IP messages into session initiation protocol (SIP) for Cellular (SIP-C) messages which may comprise SIP messages with extensions. SIP-C may be used for initiating and managing multimedia sessions using IP. For example, SIP-C provides flexible session setup and management for various applications (e.g., voice, multimedia, etc.) while wireless protocols provide session setups, call delivery, global roaming, feature support (call waiting, call transfer, call four, calling line ID, calling and presentation, etc.). SIP-C is any protocol that is used or based SIP that encapsulates and/or converts at least a portion of a wireless protocol message for providing wireless services.

At a high level, system 100 includes radio access network (RAN) 116 connecting mobile devices 110a-b to the core wireless network 118, the IP network 120, and cellular gateway control function (CGCF) 114 connecting telephone devices 138 to the IP network 120. In RAN 116, each mobile device 110a-b comprises an electronic device operable to receive and transmit wireless communication with system 100. As used in this disclosure, mobile device 110 is intended to encompass a cellular phone, a data phone, a pager, a portable computer, smart phone, personal data assistant (PDA), one or more processors within these or other devices, or any other suitable processing device capable of communicating information over the wireless link. It will be understood that there may be any number of mobile devices 110 communicably coupled to RAN 116.

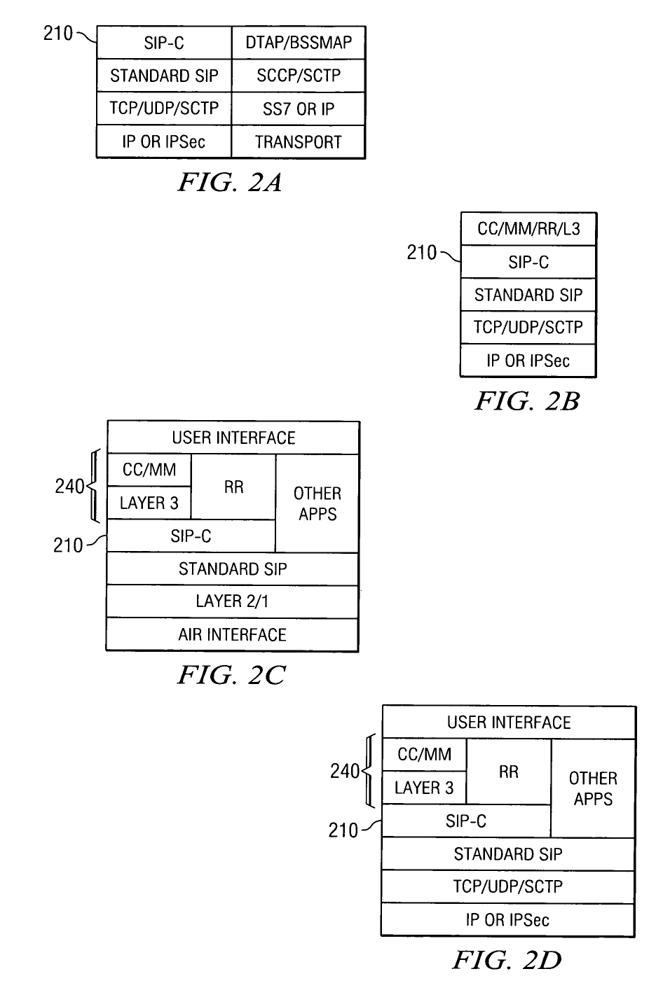

Telephony device 138 is any suitable device operable to transmit a telephone call using any appropriate wireless or wireline protocol. For example, telephony device 138 may be a Plain Old Telephony System (POTS) telephone, a VoIP telephone, a SIP phone (138c), a SIP-C enables phone (138a), a UMA/GSM device (138b), a VoIP enable computer (138d), or any other suitable device. In one embodiment, the telephony device 138 is a GSM device transmitting wireless protocol messages (GSM messages), as described in more detail below. Telephony device 138 generates requests and/or responses and communicates them to mobile devices 110a-b located in RAN 116. An example protocol stack is illustrated in FIG. 2D.

In general, CGCFs 114a and 114b may provide internetworking between IP network 120 and core network 118. As appropriate, CGCF 114 can include any software, hardware, and/or firmware operable to convert between wireless and/or wireline protocols and SIP-C messages. For example, CGCF 114 may receive a wireless protocol message from telephony device 138 and encapsulate the wireless protocol message in a SIP-C message, performing the functions similar to CGCF 114 described below. In addition, CGCF 114 may also be operable to convert other communication protocols to a SIP-C message. For example, CGCF 114 may be connected to an IP phone or any other suitable device using wireline protocols. CGCF 114 may receive wireline protocol messages from a telephony device 138 and generate a SIP-C message based, at least in part, on the wireline protocol message. In some embodiments, CGCF 114 is operable to originate and/or terminate SIP VoIP using the SIP-C protocol.

CGCF 114a and 114b can include any software, hardware, and/or firmware operable to translate, map or otherwise convert between wireless protocol messages and SIP-C messages. In some embodiments, CGCF 114 may convert between SIP and UMA messages. In general, SIP-C messages are SIP messages incorporating a portion or a whole of a wireless protocol message and may be routed through an IP network using standard SIP processing. In some embodiments, CGCF 114a may generate SIP-C messages and transmits the SIP-C messages to CGCF 114b via IP network 120 thereby tunneling wireless protocols over the IP network 120. In addition, CGCF 114a may receive from CGCF 114b a SIP-C message encapsulating a wireless protocol message and reconstruct the wireless protocol message using the SIP-C message. An example protocol stack is illustrated in FIG. 2C. CGCF 114 may generate the SIP-C messages in response to a selection made by a user of CGCF 114, a call session request received from mobile devices 110, or any other suitable event. In one embodiment, CGCF 114 may perform two functions when generating the SIP-C message: (1) encapsulating at least a portion of the wireless protocol message; and (2) translating parameters of the wireless protocol message to associated SIP parameters such as SIP headers. In the case of reconstructing the a wireless protocol message, CGCF 114 may unencapsulate the portion of the wireless protocol message and translate parameters from SIP parameters to wireless protocol parameters.

In regards to encapsulation, CGCF 114 may encapsulate a portion of the wireless protocol message in an extension of a conventional SIP message thereby generating the SIP-C message. For example, CGCF 114 may add a multipart Multi-Purpose Internet Mail Extensions (MIME) to a standard SIP message with appropriate MIME headers and, thus, form the SIP-C message. In some embodiments, CGCF 114 encapsulates a GSM/UMTS Direct Transfer Application sub-Part (DTAP)/Layer 3 message in a MIME extension of a SIP message as illustrated in FIG. 2A. In some embodiments, CGCF 114 encapsulates the entire GSM/UMTS Mobility Management (MM), Connection Management (CM), and DTAP message in the MIME body of the type “application/cellular.” In some embodiments, an MSC or other portion of the cellular core network 118 might embed the CGCF server functionality. In this case, the protocol stack for such a combination is illustrated in FIG. 2B.

Turning to translation, in forming the headers of the SIP-C message, CGCF 114 may translate, map, or otherwise convert parameters from the wireless protocol message to appropriate SIP parameters. For example, CGCF 114 may set the ‘To:’ header field in a SIP INVITE requests to the reflected dialed number (Called Party Number) of the received wireless protocol message. In addition, CGCF 114b also converts SIP-C messages to wireless protocol messages for transmission through core network 118. In particular, CGCF 114b may unencapsulate the wireless protocol message from the SIP-C extension. Also, CGCF 114b may translate or otherwise map SIP-C parameters such as headers to one or more wireless protocol parameters. After CGCF 114b generates the wireless protocol message, CGCF 114b transmits the message to core network 118.

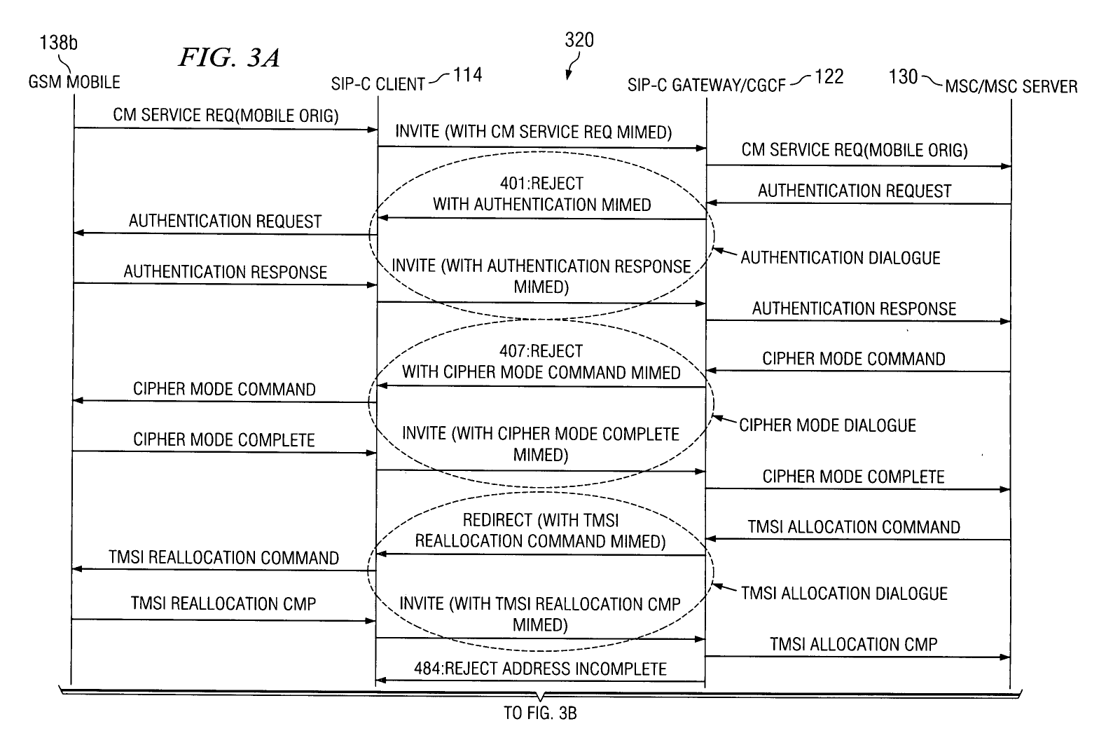

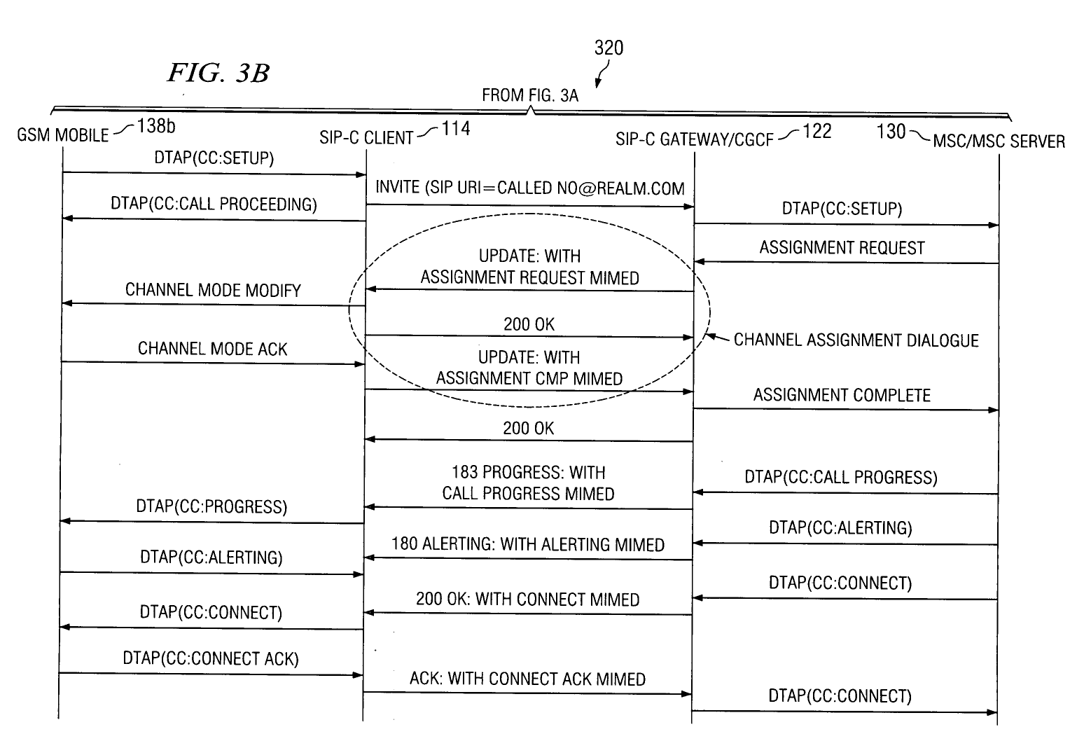

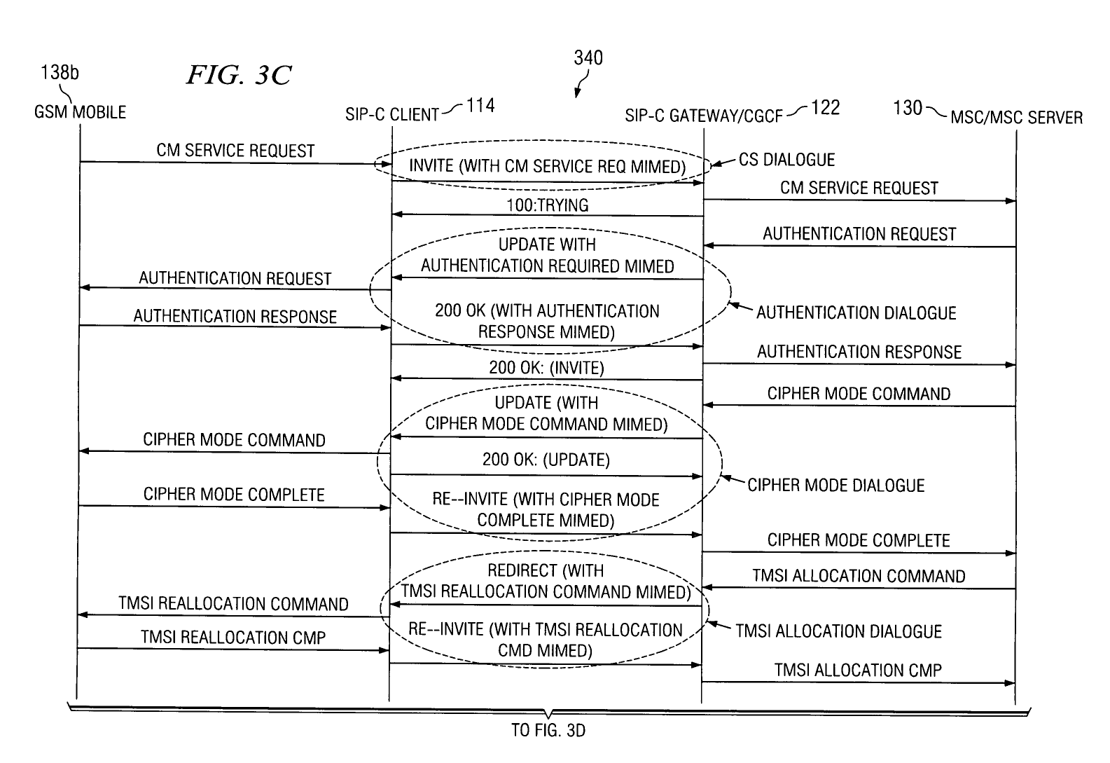

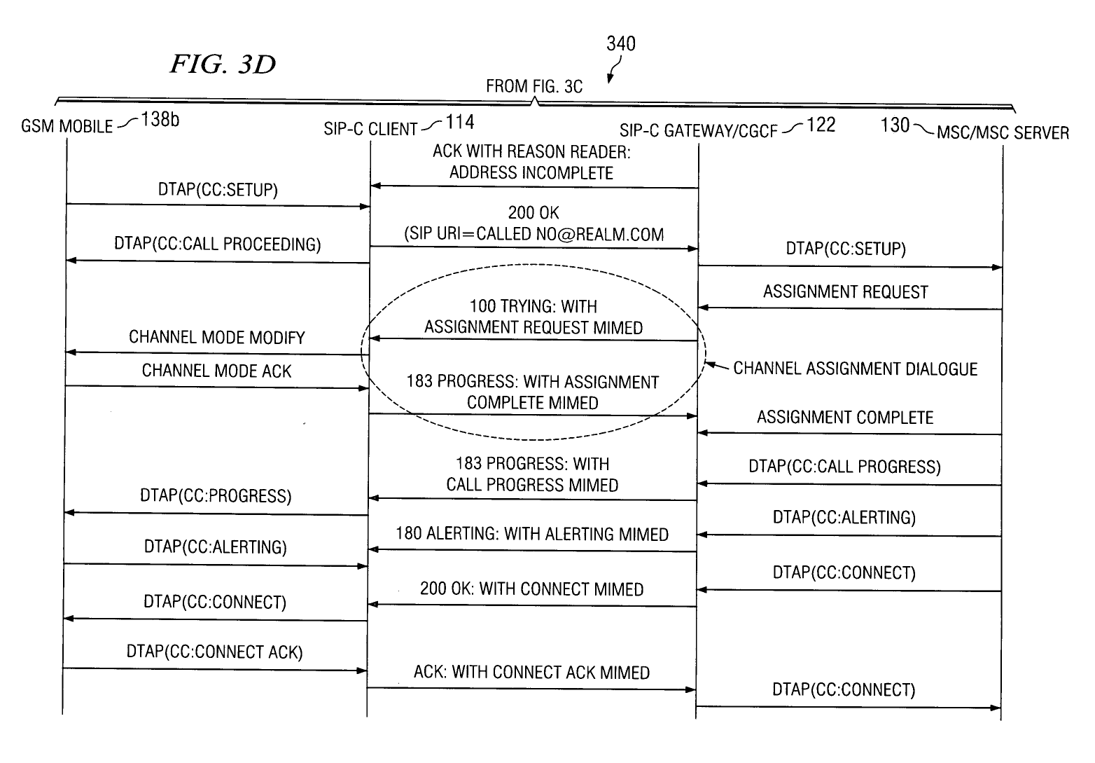

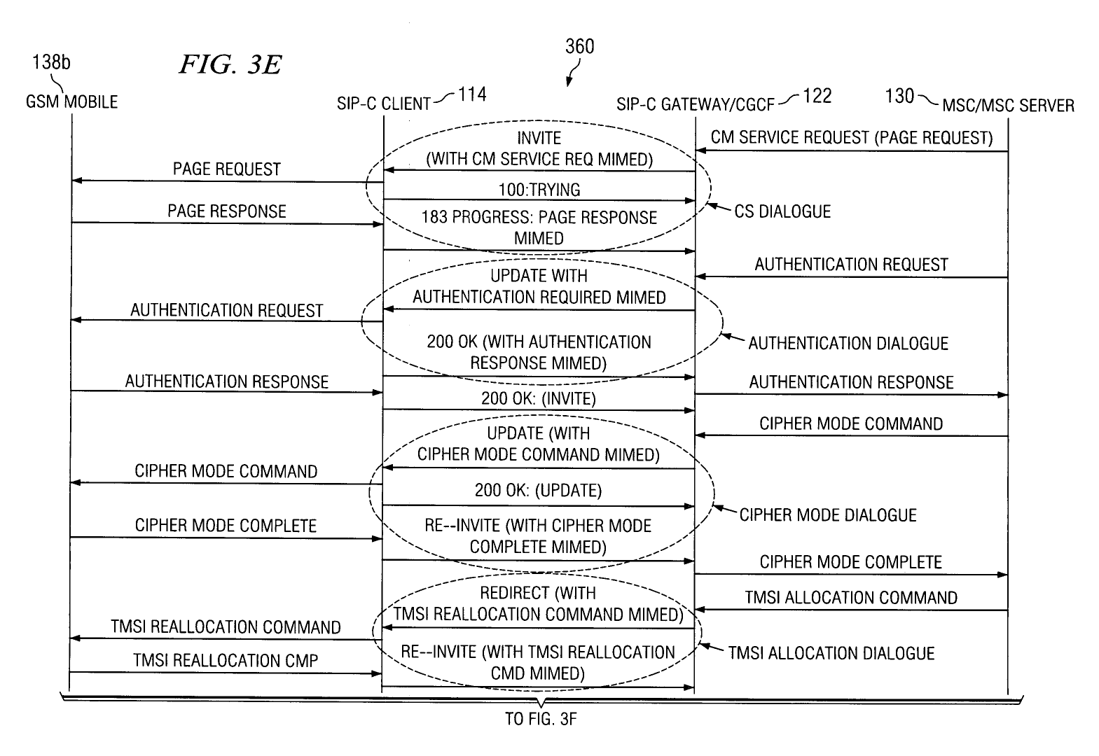

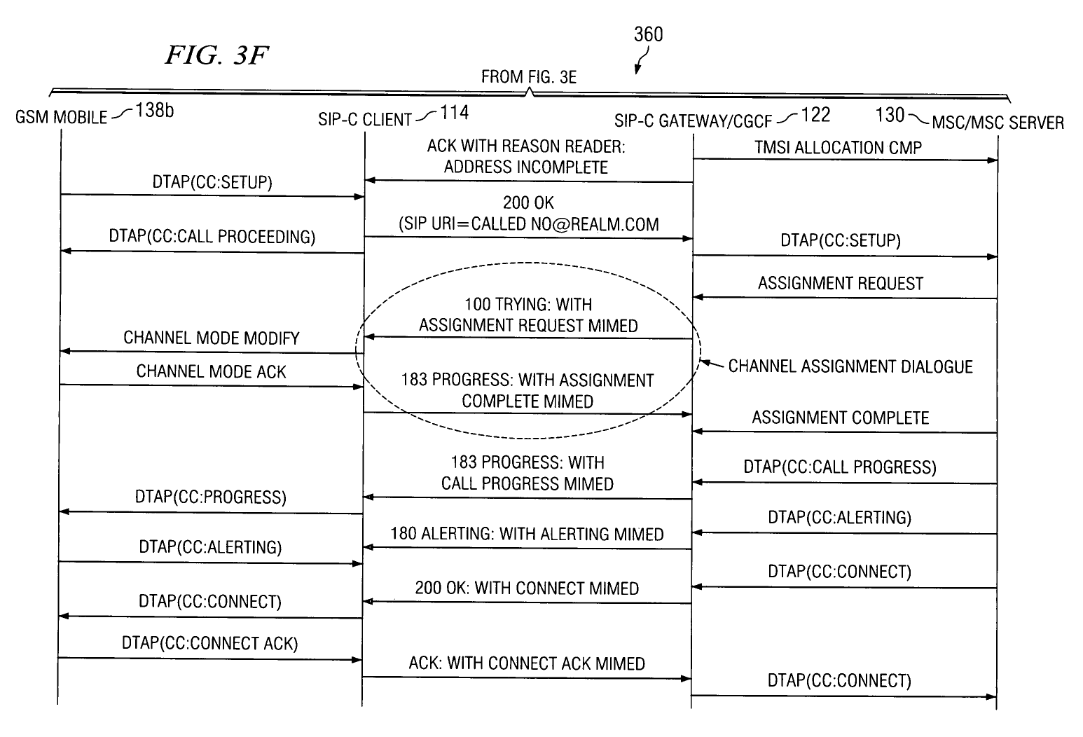

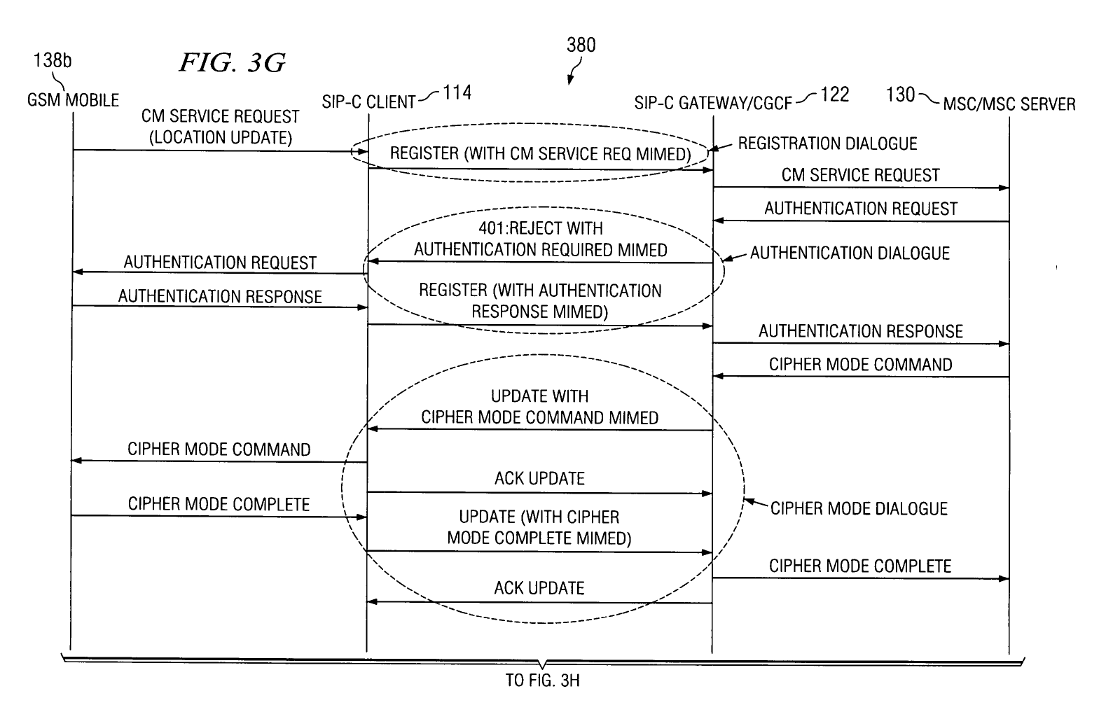

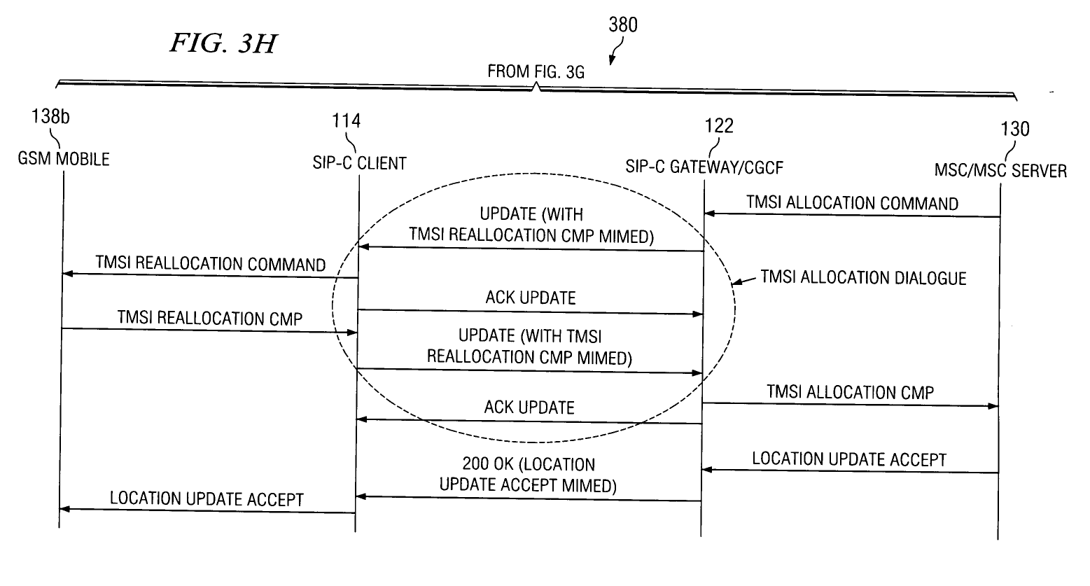

CGCF 114b may, in one embodiment, emulate or otherwise represent itself as a BSC 128 or other network element of core network 118. Thus, CGCF 114b may be queried by MSC's in core network 118 like any other BSC 128. In a particular embodiment, CGCF 114b may include a database, or access to a database, of SIP-C clients 114 or other suitable endpoints or other devices to which CGCF 114b may establish a communication session and/or forward voice or other media. Thus, CGCF 114a may be registered with CGCF 114b. In some embodiments, CGCF 114b may have an A+/IuCS+ or an A interface, as defined in the GSM/UMTS specifications 24.008/04.08/08.08, to core network 118. To provide some of the features and functions of the wireless protocol across IP network 120, CGCF 114b may create sub-dialogues within the main SIP dialog in order to map the wireless protocol state machine (e.g., GSM/UMTS DTAP/Layer3 state machine) to the SIP state machine as discussed in more detail with FIGS. 3A-D.

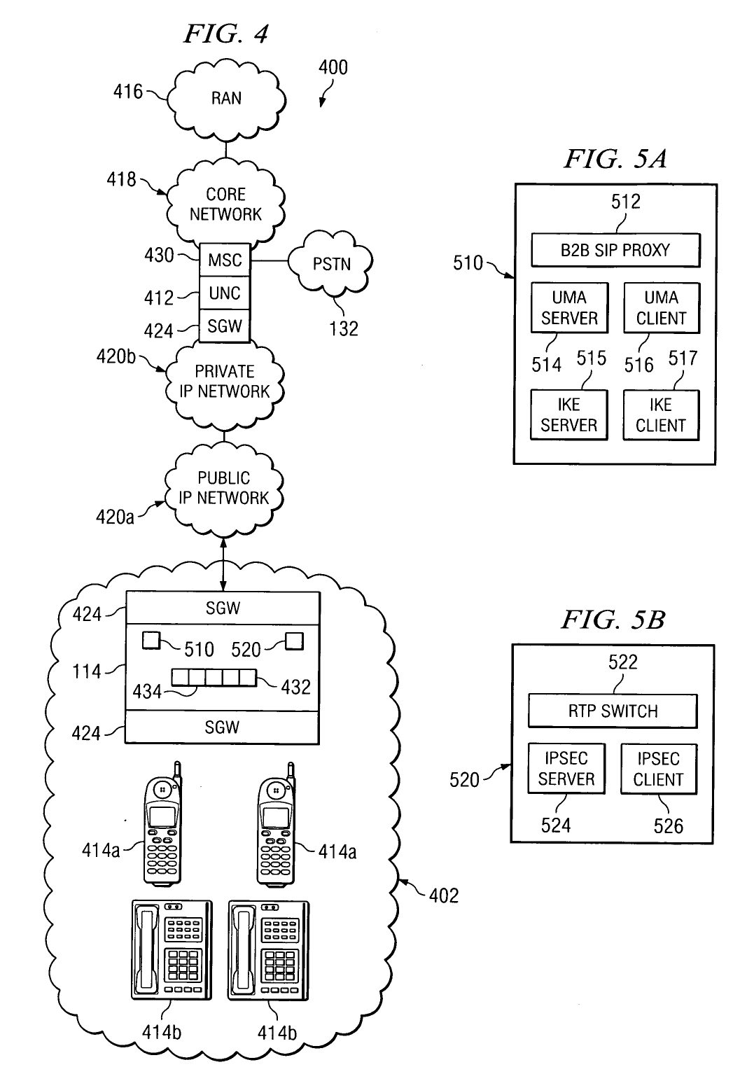

In addition, CGCF 114a can include any software, hardware, and/or firmware operable to locally switch messages between device 138. CGCF 114a may be operable to receive a message from device 138 and identify a destination of the message. CGCF 114a may identify a destination by realizing the address of the termination device or, for example, being provisioned to switch traffic received from a particular device, port, or session to another device, port or session. In the event that the destination of the message is a different device 138, CGCF 114 may convert the message to a different protocol, if appropriate, and route the message to the receiving device 138. For example, CGCF 114 may receive a SIP message from device 138a and determine that the SIP-C message is destined for a UMA device 138b. In response to at least determining that the destination is local, CGCF 114a may convert the SIP-C message to a UMA message and transmit the converted message to the appropriate UMA device 138b. Similarly, in the event that CGCF 114a receives a UMA message from device 138b and determines that the receiving device is device 138a, CGCF 114a may convert the UMA message to a SIP-C message and transmit the converted message to the appropriate SIP-C device 138. To facilate the local switching of traffic, CGCF 114 may include a SIM bank (not illustrated) that associates SIM cards to SIP devices 138a and 138c in order to represent these devices 138 to core network 118 as cellular devices. By doing so, core network 118 may maintain location information associated with SIP deivces 138. (See FIGS. 4 and 5 below).

RAN 116 provides a radio interface between mobile devices 110 and core network 118 that may provide real-time voice, data, and multimedia services (e.g., a call) to mobile devices 110. In general, RAN 116 communicates air frames 124 via radio frequency (RF) links. In particular, RAN 116 converts between air frames 124 to wireline messages for transmission through core network 118. RAN 116 may implement, for example, one of the following wireless interface standards during transmission: IS-54 (TDMA), Advanced Mobile Phone Service (AMPS), GSM standards, CDMA, Time Division Multiple Access (TDMA), General Packet Radio Service (GPRS), ENHANCED DATA rates for Global EVOLUTION (EDGE), or proprietary radio interfaces.

RAN 116 may include Base Stations (BS) 126 connected to Base Station Controllers (BSC) 128. BS 126 receives and transmits air frames 124 within a geographic region of RAN 116 called a cell and communicates with mobile devices 110 in the cell. Each BSC 128 is associated with one or more BS 126 and controls the associated BS 126. For example, BSC 128 may provide functions such as handover, cell configuration data, control of RF power levels or any other suitable functions for managing radio resource and routing signals to and from BS 126. MSC 130 handles access to BSC 128 and CGCF 114, which may appear as a BSC 128 to MSC 130. MSC 130 may be connected to BSC 128 through a standard interface known as the A-interface. In addition, MSC 130 may be connected to Public Switched Telephone Network (PSTN) 132. While RAN 116 typically handles radio-related functionality, core network 118 switches and routes calls and data connections to external networks such as IP network 120.

Core network 118 typically includes various switching elements and gateways for enabling communication via a number of RANs, such as RAN 116, and also interfaces the cellular system with other communication systems such as IP network 120 via mobile switching center (MSC) 130. In accordance with the GSM standard, core network 118 includes a circuit switched (or voice switching) portion for processing voice calls and a packet switched (or data switching) portion for supporting data transfers such as, for example, e-mail messages and web browsing. The circuit switched portion includes MSC 130 that switches or connects telephone calls between RAN 116 and IP network 120. The packet-switched portion, also known as General Packet Radio Service (GPRS), includes a Serving GPRS Support Node (SGSN) (not illustrated), similar to MSC 130, for serving and tracking mobile devices 110a-b, and a Gateway GPRS Support Node (GGSN) (not illustrated) for establishing connections between packet-switched networks and mobile devices 110a-b. The SGSN may also contain subscriber data useful for establishing and handing over call connections. Core network 118 may also include a home location register (HLR) for maintaining “permanent” subscriber data and a visitor location register (VLR) (and/or a SGSN) for “temporarily” maintaining subscriber data retrieved from the HLR and up-to-date information on the location of the mobile station. In addition, core network 118 may include Authentication, Authorization, and Accounting (AAA) that performs the role of authenticating, authorizing, and accounting for devices operable to access core network 118. In short, core network 118 is operable to transmit and receive wireless messages via RAN 116.

Network 120 facilitates wireline communication between CGCF 114 and any other computer. As described, network 120 communicates IP packets to transfer voice, video, data, and other suitable information between network addresses. In the case of multimedia sessions, network 120 uses Voice over IP (VoIP) protocols to set up, route, and tear down calls. Network 114 may include one or more local area networks (LANs), metropolitan area networks (MANs), wide area networks (WANs), all or a portion of the global computer network known as the Internet, and/or any other communication system or systems at one or more locations. In the illustrated embodiment, IP network 120 includes SIP proxy servers 134 for routing SIP-C messages. Each SIP proxy server 134 can be any software, hardware, and/or firmware operable to route SIP-C messages to other SIP proxies 134, gateways, SIP phones, CGCF 114, CGCF 114, and others. In routing SIP-C messages, SIP-C encapsulation may be transparent to standard SIP Proxy servers 134. The standard SIP proxy servers 134 may only act on the standard SIP headers of the SIP-C message for routing/forwarding decisions of the SIP message and ignores the MIME encapsulation in the message body content header.

In one aspect of operation, telephony device 138 transmits a call request to CGCF 114 for establishing a call with a mobile device 110. In response to at least receiving the call requests, CGCF 114 generates a SIP-C call initiation request based on the received call request that encapsulates at least a portion of a wireless protocol message in a SIP message. In the event that the call requests transmitted by telephone device 138 is a GSM message, CGCF 114 encapsulates the GSM message in a MIME extension of a SIP message thereby forming the SIP-C message. After generating the SIP-C message, CGCF 114 transmits the SIP-C message to the appropriate SIP proxy server 134. One or more SIP proxy servers 134 route the SIP-C message to CGCF 114 through IP network 120 based on the SIP headers included in the SIP-C message. As a result, the encapsulated wireless protocol message may be transport through the IP network 120 transparently. Upon receipt of the SIP-C message, CGCF 114 unencapsulates the wireless protocol message and translates any appropriate headers to associated wireless-protocol parameters for routing through the core network 118. After the appropriate BSC 128 receives the wireless-protocol message, BSC 128 converts the wireless protocol message to an air frame and wirelessly transmits it to the mobile device 110 via an associated BS 126 and wireless link.

In another aspect of operation, mobile device 110a transmits a call initiation request to BS 126 via an air frame link and BS 126 then passes the GSM message to BSC 128. BSC 128 transmits the request to MSC 130 for paging core network 118. MSC 130 determines the appropriate BSC 128 to receive the GSM message. Since MSC 130 is also operable to query CGCF 114, MSC 130 determines that the destination device is associated with CGCF 114 and forwards the GSM message to CGCF 114. CGCF 114 encapsulates the GSM message in a SIP message to form the SIP-C message and tunnels the GSM message through IP network 120 to CGCF 114. SIP-C unencapsulates the wireless protocol message and forwards the message to device 138b.

FIG. 2A-2D illustrate example protocol stacks in accordance with communication system 100 of FIG. 1. More particularly, example protocol stacks illustrate that the wireless protocol is encapsulated in the application layer as identified by SIP-C 210. It will be understood that the example protocol stacks are for illustration purposes only. System 100 may use the same, some, or different layers when tunneling wireless protocols through IP network 120 without departing from the scope of this disclosure.

FIG. 2A illustrates an example protocol stack 200 for CGCF 114. As mentioned above, protocol stack 200 includes SIP-C layer 210 for encapsulating the wireless protocol message. In the event that the message is termination in RAN 116, CGCF 114 generates the wireless protocol message by encapsulating the message and performing any appropriate translations.

FIG. 2B illustrates an example protocol stack 220 in the event that the functionality of CGCF 114 and MSC 130 are combined. In this case, the combined device would directly receive and transmit wireless protocol messages from core network 118 and, in addition, perform the internetworking between IP network 120 and core network 118.

FIG. 2C illustrates an example protocol stack 230 for CGCF 114. In the illustrated embodiment, the wireless protocol message 240 is encapsulated in the application layer of protocol stack 220 for tunneling through IP network 120. As discussed above, CGCF 114 may receive a wireless and/or wireline protocol message and generate the SIP-C message as illustrated in protocol stack 230. In the event that a wireline protocol message is received, CGCF 114 merely converts the wireline message to a SIP-C message that encapsulates a wireless protocol message.

FIG. 2D illustrates an example protocol stack 250 for SIP-C enabled device 138a. In particular, device 138a directly generates SIP-C messages including an encapsulated wireless protocol message 240 and transmits the SIP-C message over an air interface to CGCF 114. Since the message is already SIP-C enabled, CGCF 114 merely passes the message to IP network 120 for routing to CGCF 114. Similarly, when a SIP-C message is terminating at device 138a, CGCF 114 merely passes the message to device 138a.

FIGS. 3A-H illustrate call flow diagrams of a signaling process of system 100 in FIG. 1 in accordance one embodiment of the present invention. FIGS. 3A to D illustrate two implementations (call flows 320 and 340, respectively) of SIP-C for call origination from cgcf 114. FIGS. 3E and 3FD illustrates one implementation of SIP-C for call termination at cgcf 114. FIGS. 3G and H illustrates one implementation of SIP-C for call registration at CGCF 114. Call flows 320, 340, 360, and 380 are described with respect to system 100 of FIG. 1, but call flows 320, 340, 360, and 380 could be used by any other device or components. Moreover, system 100 may use other suitable techniques for performing these tasks. System 100 may also use call flows with additional steps, fewer steps, and/or different steps, so long as the call flows remain appropriate.

As discussed above, SIP has a relatively few methods as compared to many wireless protocols such as GSM. In overcoming this limitation, sub-dialogues within conventional SIP dialogues may be used to tunnel wireless protocol services, instructions and/or parameters through IP network 120. The sub-dialogues are based on SIP instructions such that CGCF 114 and CGCF 114 may determine wireless protocol instructions and parameters based on the received SIP sub-dialogue. As illustrated in FIG. 1, the tunneling occurs between CGCF 114a and CGCF 114b and, thus, the sub-dialogue is between CGCF 114a and CGCF 114b. For example, CGCF 114a and CGCF 114b may use one or more the following SIP-C sub-dialogues:

Establish Dialogue: This dialogue establishes the MM layer so that Connection Management(CM) layer can use its services.

Authenticate Dialogue: This dialogue is initiated by the network to authenticate the subscriber.

Cipher Mode Dialogue: This dialogue is established by the network to start cipher mode with the user device and exchange cipher keys for this purpose.

TMSI Allocate Dialogue: This dialogue is established by the network to allocate a temporary identity to the subscriber.

Channel Assignment Dialogue: This dialogue is establish to assign a session a channel for transmission.

Registration Dialogue: This dialogue is established to start the registration process between the network and user.

IMSI Detach Dialogue: This dialogue can be initiated by the network or the user to detach the IMSI.

Identity Req Dialogue: This dialogue is initiated by the network to request and verify the identity of the user.

It will be understood that the above SIP-C sub-dialogues are for illustration purposes only and that CGCF 114a and CGCF 114b may use some, none, different, or all of the identified dialogues without departing from the scope of this disclosure.

FIG. 4 illustrates a communication system 400 for providing localized switching for Unlicensed Mobile Access (UMA) devices 414 (as previously described) in an enterprise network 402. UMA is an extension of GSM/GPRS mobile services into enterprise network 402 achieved by tunneling certain GSM/GPRS protocols between enterprise network 402 and core network 418. In other words, UMA devices 414 may access wireless GSM/GPRS services through access points of enterprise network 402 using unlicensed spectrum (e.g., Bluetooth, 802.11) and, thus, without using RAN 416. As a result, UMA devices 414 may roam and handover between enterprise network 402 and RAN 416.

Enterprise network 402 is a network associated with an enterprise. The enterprise may comprise a corporate or business entity, a government body, a non-profit institution, or any other organization with enterprise devices such as UMA devices 414a and SIP devices 414b. The enterprise may be the owner of devices 414. Of course, the enterprise may also lease enterprise devices or may hire contractors or agents who are responsible for maintaining, configuring, controlling, and/or managing enterprise devices.

In the illustrated embodiment, enterprise network 402 facilitates wireless and/or wireline communication between UMA devices 414a, SIP devices 414b and CGCF 114. In some embodiments, enterprise network 402 communicates, for example, IP packets encoding voice, video, data, and other suitable information between network addresses. In addition, while enterprise network 402 is illustrated as a single network, enterprise network 402 may comprise a plurality of networks. In short, enterprise network 402 is any suitable network that includes UMA devices 414a and/or SIP devices 414b.

CGCF 114 can include any software, hardware, and/or firmware operable to locally switch messages in enterprise network 402. In addition, CGCF 114 may translate, map, or otherwise convert between SIP and UMA messages. CGCF 114 is operable to receive a message from enterprise network 402 and identify a destination of the message. CGCF 114 may identify a destination by realizing the address of the termination device or, for example, being provisioned to switch traffic received from a particular device, port, or session to another device, port or session. In the event that the destination of the message it is within enterprise network 402, CGCF 114 may convert the message to the appropriate protocol if appropriate and route the message to the receiving device 414. For example, CGCF 114 may receive a SIP message from a SIP device 414b in enterprise network 402 and determine that the SIP message is destined for a UMA device 414a in enterprise network 402. In response to at least determining that the destination is local, CGCF 114 may convert the SIP message to a UMA message and transmit the converted message to the appropriate UMA device 414a. Similarly, in the event that CGCF 114 receives a UMA message and determines that the receiving device is SIP device 414b in enterprise network 402, CGCF 114 may convert the UMA message to a SIP message and transmit the converted message to the appropriate SIP device 414b. In addition, CGCF 114 also routes control plane signals based on the originating device's type of DN. For example, if the originating device has an IP-PBX DN, then the control plane message will be transmitted to the IP-PBX. If the originating device has a UMA/GSM DN, then the control plane signal with be transmitted to UNC 412 through IP network 420.

UMA Network Controller (UNC) 412 may authenticate and authorize access to GSM voice and GPRS data services. UNC 412 may also switch messages between devices in the enterprise network 402. In this embodiment, messages both originating and terminating in enterprise network 402 are transmitted out of enterprise network 402 to UNC 412 and then transmitted back to enterprise network 402. UNC 412 can include any software, hardware, and/or firmware operable to manage UMA devices in enterprise network 402. For example, UNC 412 may perform registration for UMA control services, set up or tear down bearer paths, terminate secure remote access tunnels from enterprise devices, and other suitable services. In addition, UNC 412 appears as a base station subsystem to core network 418 and, thus, provides location information for UMA devices 414. UNC 412 may be connected to MSC 430 and SGSN (not illustrated) an A-interface and Gb interface respectively. As a result, core network 418 perceives UNC 412 as a base station controller, and core network 418 may be unaware of the different access mechanisms being supported by UNC 412 compared to an actual base station controller. In general, UNC 412 monitors devices and enterprise network 402. For example, UNC 412 may store the identity, location, and/or capabilities of the devices in enterprise network 402 during registration. UNC 412 may require such information to provide support services and/or potentially handover functionality for UMA devices 414. After registration is approved by UNC 412, the current location information is updated in core network 418, and from that point on, in one embodiment, all mobile voice and data traffic is routed to the handset via enterprise network 402 rather than the cellular RAN 416. In some embodiments, both roaming and handover is transparent to a user of UMA devices 414.

In one aspect of operation, UMA device 414 transmits a registration request to UNC 412 via IP network 420. CGCF 114 receives the registration request from UMA 412, determines that the registration is a control plane signal for a UMA/GSM DN, and transmits the control plane signal to UNC 412. In the event the registration request was transmitted in SIP protocol, CGCF 114 may convert the SIP registration request to a UMA registration request. As a result, UNC 412 identifies any enterprise device 414, either UMA device 414 and/or SIP device 414b, as a UMA client as long as, in one embodiment, UMA device 414a and/or SIP device 414b are associated with a UMA/GSM DN. As discussed above, during registration, UNC 412 may store information such as location, identity, and/or capabilities of the registering enterprise device. In the event that UMA device 414 transmits bearer plane signals for termination in enterprise network 402, CGCF 114 directly routes the messages between the appropriate network devices with exiting enterprise network 402. More particularly, CGCF 114 identifies the origination device also resides in enterprise network 402, determines the protocol type of the originating and terminating device, and coverts between protocols if appropriate such as between UMA and SIP messages.

FIGS. 5A and 5B illustrates modules 510 and 520 of CGCF 114 for managing control plane signals and bearer plane signals, respectively. It will be understood that the illustrated modules 510 and 520 are for illustration purposes only. CGCF 114 may include all, some, or different features and functions of modules 510 and 520 without departing from scope of this disclosure. Moreover, CGCF 114 may use any other suitable modules for performing the same functions as modules 510 and 520.

Referring to FIG. 5A, modules 510 manages control plane signals to and from UMA devices 414a and SIP devices 414b. In general, module 510 establish a secure tunnel with UNC 412, routes messages based on the type DN associated with device 414, and converts between wireless and wireline protocol if appropriate. In some embodiments, module 510 identifies the type of DN associated with the enterprise device 414 and routes the control signal based, at least in part, on the type of DN. For example, module 510 may determine that a control signal is associated with a UMS/GSM DN and, thus, forwards the control signal to UNC 412. In the event that a SIP control signal is associated with a UMS/GSM DN, module 510 may convert the SIP control message to a UMA control signal before transmitting the message to UNC 412. In another example, module 510 may determine that a control plane signal is associated with a IP-PBX DN and, thus, forward the control signal to the associated IP-PBX. In the event that a UMA control signal is associated with a IP-PBX DN, module 510 may convert the UMA control message to a SIP control signal before transmitting the control message to the associated IP-PBX.

At a high-level, module 510 includes back to back (B2B) SIP Proxy 512, a UMA server module 514, a UMA client 516, IKE server 515, and IKE client 517. The B2B SIP proxy 512 can include any software, hardware, and/or firmware operable to receive SIP control messages, identify the type of DN associated with the control message, and transmit the SIP control message to the associated IP-PBX for IP-PBX DNs and pass the SIP control message to UMA client 516 for UMA/GSM DNs. UMA client 516 can include any software, hardware, and/or firmware operable to convert between UMA control messages and SIP control messages and receive control messages from and transmit control messages to UNC 412. In addition, UMA client 516 may receive UMA control messages from UMA server 514 and transmit the received UMA control messages to UNC 412. UMA server 514 can include any software, hardware, and/or firmware operable to receive control messages from and transmit messages to UMA devices 314. In additional, UMA server 514 may receive control messages from and pass control messages to UMA client 516 for transmitting to UNC 412. IKE client 517 establishes secure tunnels with UNC 412 using any suitable encryption technique. For example, the encryption technique may be based on Internet Key Exchange (IKE). In this case, UNC 412 authenticates enterprise device 414. Initially, IKE client 517 may transmit an identifier of device 414 to UNC 412. UMA devices 414a may contain a UMTS SIM (USIM) that stores the identifier. CGCF 114 may store the identifier for devices that locally store the identifier such as SIP devices 414b. For example, CGCF 114 may include a SIM bank 430 that associates SIM cards 432 to SIP devices 414b in enterprise network 402. A SIM card 432 may be associated with any suitable device that can originate a call session in enterprise network 402. The SIM cards 432 in the SIM bank 430 may be reassigned as call sessions terminate and/or originate, SIP devices 414b are added and/or removed, or as a result of any other event. In addition, system 400 may not have a one-to-one correspondence between SIM cards 432 and SIP devices 414b. Further, any SIM card 432 may be assigned to any SIP device 414b. As a result, non-UMA devices such as SIP devices 414b may be represented as UMA devices to UNC 412. For UMA devices 414a, IKE server 515 passes the identifiers to IKE client 517 for authentication and establishing a secure tunnel. It will be understood that B2B SIP proxy 512, UMA client 514, UMA client 516, IKE server 515, and IKE client 517 are for illustration purposes only.

Referring to FIG. 5B, module 520 can include any software, hardware, and/or firmware operable to manage bearer plane signals to and from UMA devices 414a and SIP devices 414b. In some embodiments, module 520 locally switches bearer plane signals between enterprise network devices without exiting enterprise network 402. As discussed above, bearer plane signals of UMA devices 414a may be conventionally routed through UNC 412 before being transmitted to their termination. In some embodiments, module 520 may act as a local UNC and, thus, directly route intra-network traffic without exiting enterprise network 302. In addition, module 520 may convert between protocols if appropriate. In some embodiments, SIP devices 414b transmit bearer plane signals in RTP and UMA devices 414 transmit bearer messages in RTP/IPsec. In this case, module 520 may convert between RTP and RTP/IPsec if appropriate. For example, module 520 may be directly routing traffic from SIP device 414b to UMA device 414 and, thus, may convert between RTP and RTP/IPsec.

In the illustrated embodiment, module 520 includes an RTP switch 522, an IPsec server 524, and an IPsec client 526. RTP switch 522 is operable to identify a destination of an RTP messages and switch the RTP message based, at least in part, on the destination. For example, for intra-network traffic, RTP switch 522 may route the received RTP back to enterprise network 402 in the event that the RTP message is destined for a SIP device 414b or pass the RTP message to IPsec server 524 for local conversion t RTP/IPsec in the event that the received RTP message is destined for UMA device 414. For inter-network traffic, RTP switch 522 merely transmits the received RTP message to IP network 120 in the even the RTP message is destined for a SIP device. In the event the RTP message is destined for a UMA device, RTP switch 522 passes the RTP message to IPsec client 526 for conversion to RTP/IPsec.

In some embodiments, IPsec server 524 converts between RTP messages and RTP/IP SEC messages. IPsec server 524 may convert RTP messages to RTP/IPsec messages for transmission to UMA devices 414 in enterprise network 402. In some cases, IPsec server 524 may convert RTP/IPsec messages to RTP messages for passing to RTP switch 522. IPsec client 526 is operable to manage inter-network traffic. For example, IPsec client 526 may convert between RTP and RTP/IPsec. In some embodiments, IPsec client 526 determines a type of device of the destination and may convert messages based, at least in part, on the type of device. For example, IPsec client 526 may receive an RTP message destined for core network 118 and, thus, may convert the RTP message to an RTP/IPsec message for securely tunneling through IP network 120. In the event that IPsec client 526 receives a RTP/IPsec message destined for SIP device 414b, IPsec client 526 converts the RTP/IPsec message to an RTP message and passes the RTP message to RTP switch 522.

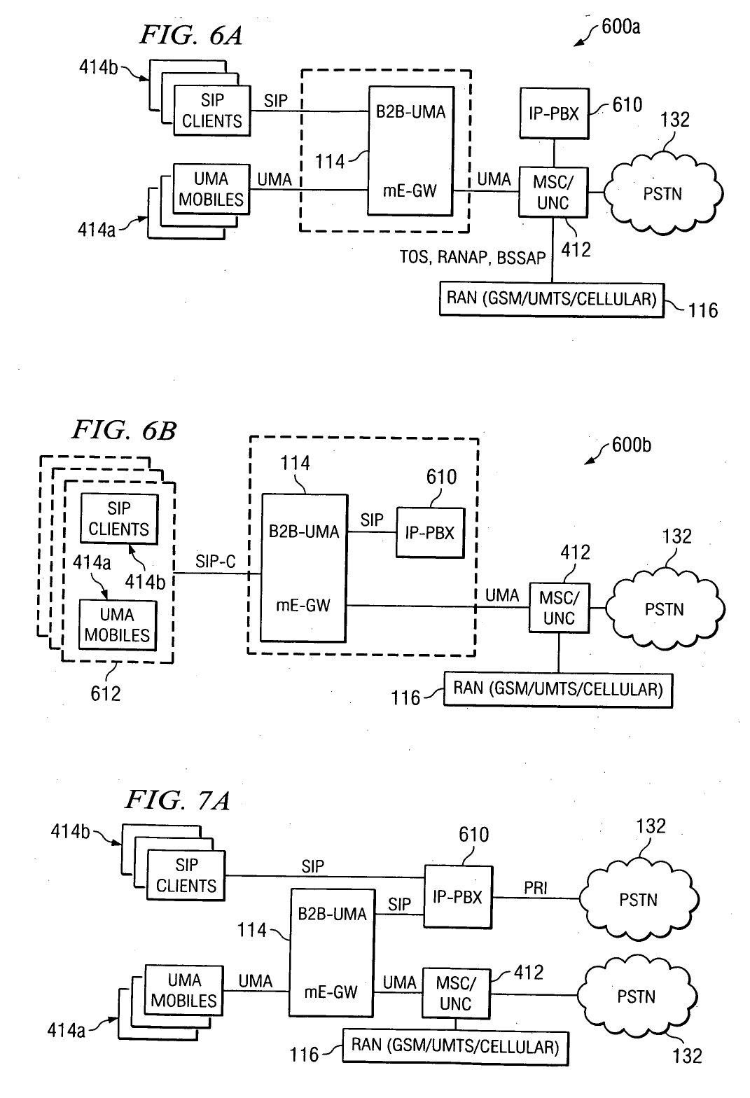

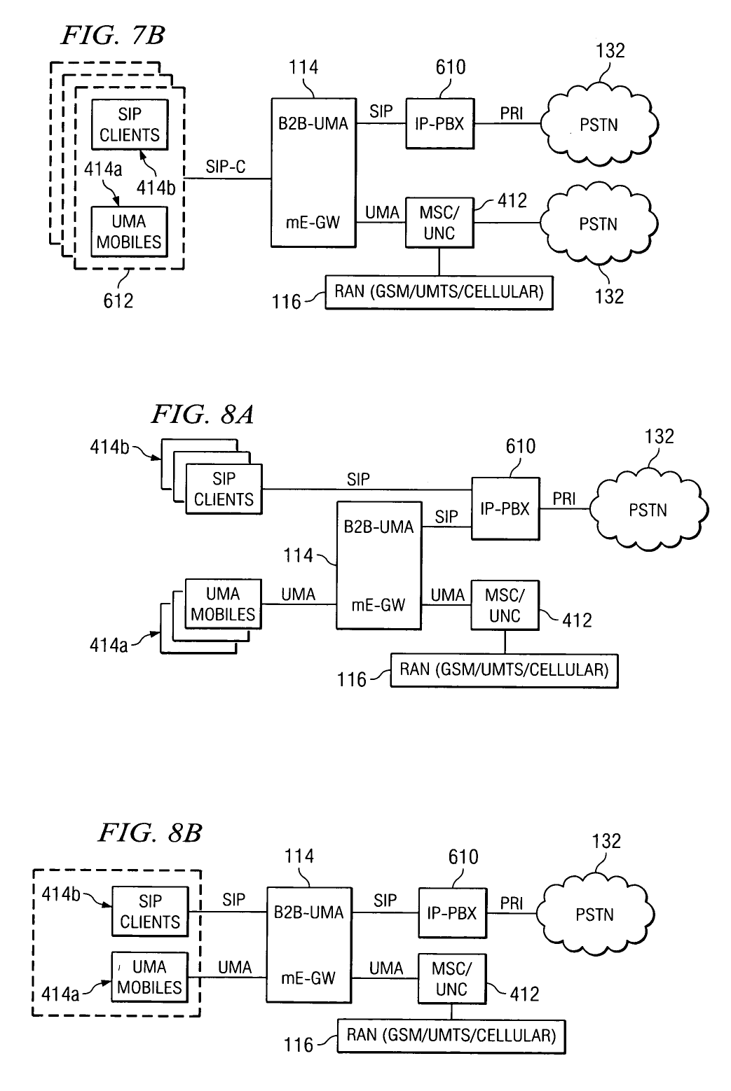

FIGS. 6, 7, and 8 illustrate different configurations of system 400 based on the types of DNs associated with enterprise devices 414. FIGS. 6A and 6B illustrate example systems 400 including enterprise devices 414 that have UMA/GSM DNs. FIGS. 7A and 7B illustrate example systems 400 including enterprise devices 414 with both UMA/GSM DNs and IP-PBX DNs. FIGS. 8A and 8B illustrate example systems including enterprise devices 414 that have IP-PBX DNs. It will be understood that these example systems 400 for illustration purposes only and system 400 may be include the same or different configurations for providing local switching in enterprise network 402.

FIGS. 6A and 6B illustrates embodiments of communication systems 400 for locally switching bearer plane signal in enterprise network 402. In some embodiments, enterprise devices 414 and/or SIP-C devices 512 have UMA/GSM DNs. As a result, enterprise devices 414 and SIP-C devices 512 in enterprise 402 are managed by UNC 412. CGCF 114 in both systems provide UMA lines to IP-PBX 610 for call delivery and termination to enterprise 402. In addition, CGCF 114 may be used to provide UMA relay for handoffs of UMA mobiles 414a between enterprise 402 and RAN 116.

Referring to FIG. 6A, in one aspect of operation, SIP client 414b transmits a request to initiate a session with UMA mobile 414a. IP-PBX 610 passes the request to CGCF 114, and CGCF 114 converts the SIP request to a UMA request and, being a control plane signal, transmits the UMA request to UNC 412. UNC 412 registers the request and transmits an acknowledgment to CGCF 114. SIP client 414b then transmits barrier plane signals to IP-PBX 610 which in turn passes the barrier plane signals to CGCF 114. CGCF 114 identifies the type of message is RTP and determines that the termination is UMA device 414a located in enterprise network 402. Prior to routing the bearer plane signal to UMA device 414a, CGCF 114 converts the RTP messages to a RTP/IPsec message. After conversion, CGCF 114 transmits the UMA messages to UMA mobile 414a. As a result of the session being registered with UNC 412, UNC 412 controls the features and functions associated with the session while bearer messages are directly routed in enterprise network 402.

Referring to FIG. 6B, in one aspect of operation, a first SIP-C devices 512 transmits a request to initiate a session with a second SIP-C device to CGCF 114. CGCF 114 unencapsulates the UMA message form the SIP-C message and transmits the UMA message to UNC 412 for registration. UNC 412 registers the request and transmits an acknowledgement to CGCF 114. CGCF 114 then locally switches RTP messages between the first and second SIP-C devices 512.

FIGS. 7A and 7B illustrate embodiments of communication system 400 for locally switching bearer messages in enterprise network 402. In some embodiments, enterprise devices 414 and/or SIP-C devices 512 may have either UMA/GSM DNs or IP-PBX DNs. For example, UMA devices 414a may have UMA/GSM DNs (as provisioned in GSM Operator's HLR) and SIP devices 414b may have IP-PBX systems. This example typically occurs when an existing enterprise network has an IP-PBX and is modified to provide services from UNC 412. In doing so, CGCF 114 may be inserted into enterprise network 402 to integrate UMA mobiles 414a into enterprise network 402. In some embodiments, IP-PBX 610 serves SIP devices 414b for call delivery and termination between enterprise 402 and PSTN while UNC 412 serves UMA devices 414a for call delivery and termination between enterprise network 402 and RAN 116. In addition, CGCF 114 may be used to provide UMA relay for handoffs of UMA mobiles 414a between enterprise 402 and RAN 116.

Referring to FIG. 7A, in one aspect of operation, SIP client 414b transmits a request to initiate a session with UMA mobile 414a. IP-PBX 610 registers the request and sends an acknowledgement to SIP device 414b. SIP client 414b then transmits barrier plane signals to IP-PBX 610 which in turn passes the barrier plane signals to CGCF 114. CGCF 114 identifies the type of message is RTP and determines that the termination is UMA device 414a located in enterprise network 402. Prior to routing the bearer plane signal to UMA device 414a, CGCF 114 converts the RTP messages to a RTP/IPsec message. After conversion, CGCF 114 transmits the UMA messages to UMA mobile 414a.

Referring to FIG. 7B, in one aspect of operation, a first SIP-C devices 512 transmits a request to initiate a session with PSTN. CGCF 114 converts the SIP-C message to a SIP message and transmits the SIP message to IP-PBX 610. IP-PBX 610 converts the SIP message to a PRI message and transmits the PRI message to PSTN. In the case that the SIP-C devices has a UMS/GMS DNs, CGCF 114 converts the SIP-C message to a UMA and transmits the UMA message to UNC 412.

FIGS. 8A and 8B illustrates communication systems 800 and 850 for providing IP-PBX DNs for enterprise devices 414. As a result, SIP clients 414a and UMA devices 414b in enterprise 402 are served by IP-PBX 610 for call delivery and termination to enterprise 402. In some embodiments, CGCF 114 may be used to provide relays for handoffs of UMA mobile devices 414a to and from enterprise 402 and RAN 116. In some embodiments, UMA mobiles 414a have permanent or pre-provisioned UMA DNs enabling UMA mobiles 414a to roam between enterprise network 402 and RAN 116. UMA devices 414a may roam in enterprise network 402 using IP-PBX DNs. In the event that UMA attempts to roam outside of enterprise network 402, UMA device 414a switches to a UMA DNs to roam in RAN 116.

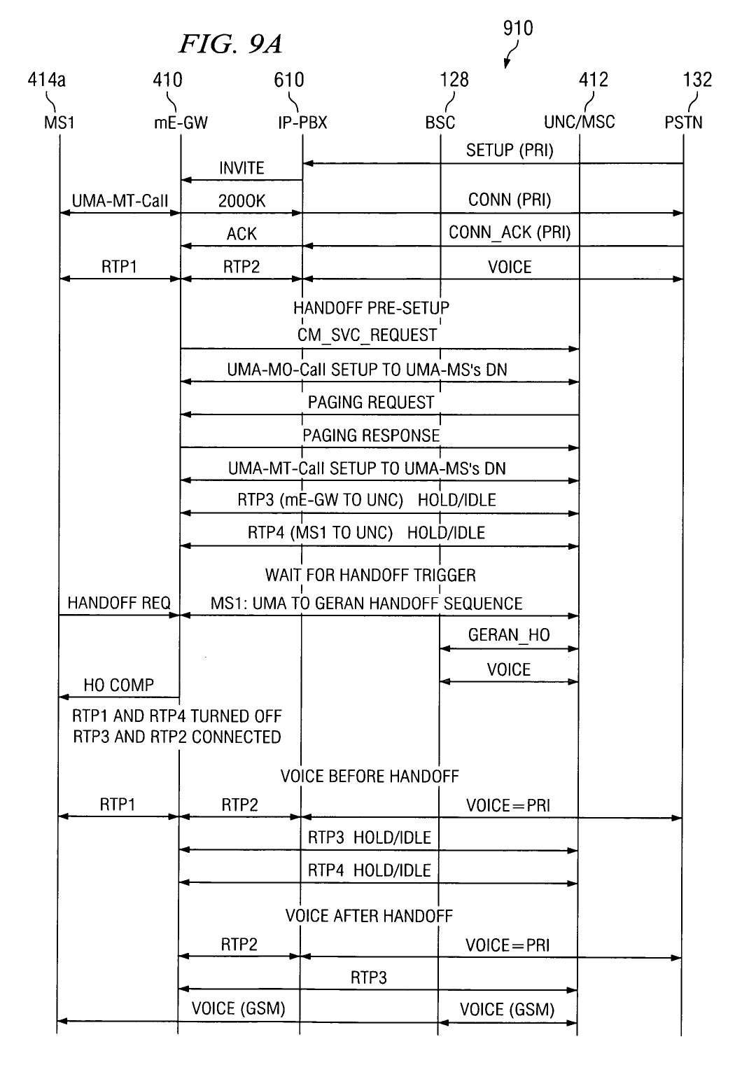

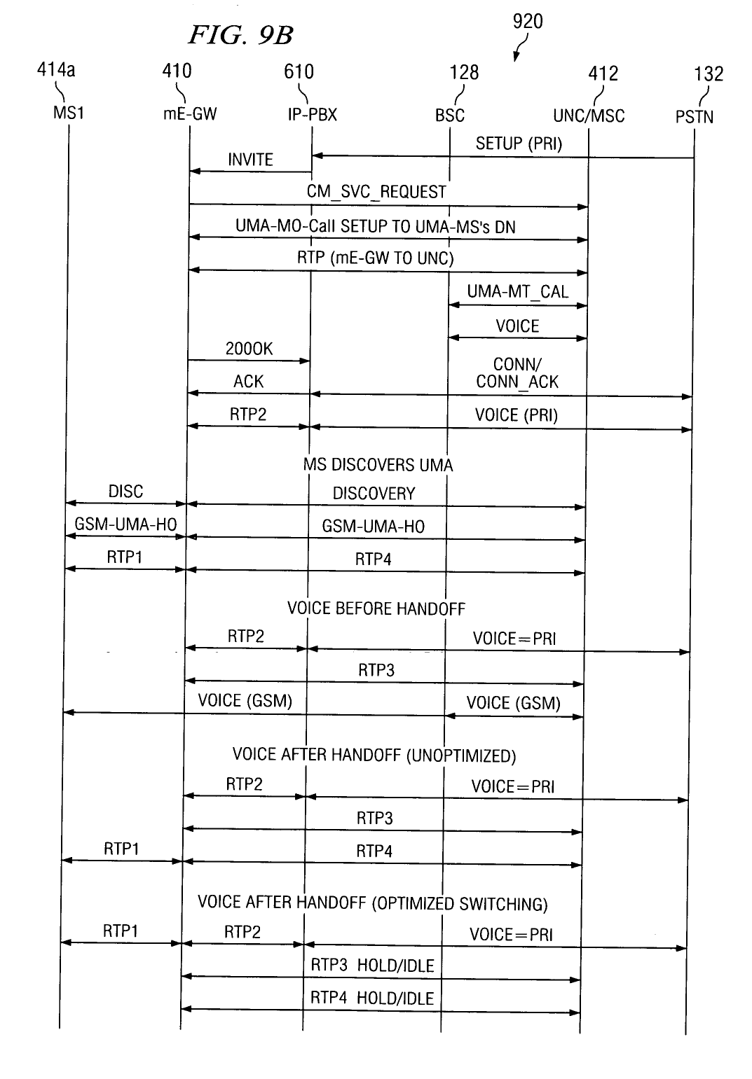

FIGS. 9A and 9B illustrate call flows in accordance with communication systems 800 and 850 of FIGS. 8A and 8B. In particular, 910 and 920 illustrate how a UMA device using a IP-PBS DNs in enterprise network 402 may roam in RAN 116. As discussed above, UMA devices 414a are also provisioned UMA DNs that are used when roaming in RAN 116. The call flows 910 and 920 illustrate handoff to RAN 116 and handoff to enterprise network 402, respectively.

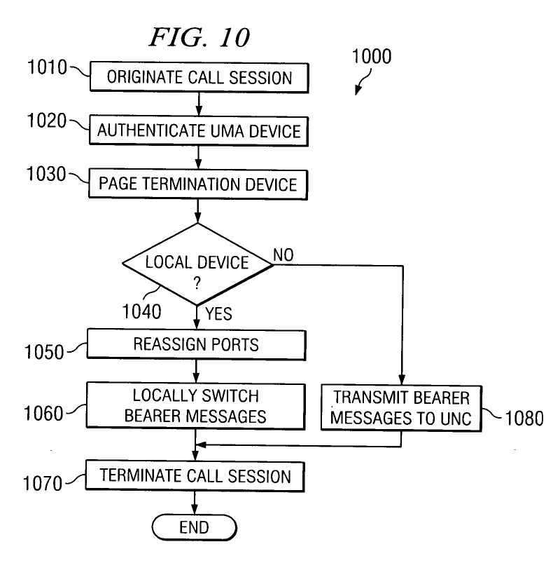

FIG. 10 is a flow diagram illustrating one embodiment of a method for establishing a call session initiated by an enterprise device. In the illustrated embodiment, the communication session comprises a call session. The communication session may comprise other or different media.

Referring to FIG. 10, the method begins at step 1010 wherein a call session is originated. The call session may be originated by any suitable enterprise device 414. As previously described, the enterprises device is comprised of native UMA devices 414a including a SIM card 432 and/or SIP devices 414b that together with associated SIM cards 432 form a UMA device for communication over the network. Next, at step 1020, the UMA device, whether native or with an associated SIM card 432, is authenticated.

At step 1030, a termination device for the call session is paged. The termination device may, in one embodiment, be paged by the core network 118 using the MSC 130. Proceeding to decisional step 1040, it is determined if the termination device is local to the originating device in enterprise network 402. One embodiment, CGCF 114 may upon receiving a call request for an enterprise device 414, determine whether the originating device is also an enterprise device 414. If the originating device 414 is also a local device to the enterprise, the CGCF 114 determines that the call session is an intra-enterprise call and the yes branch of step 1040 leads to step 1050. At step 1050, the CGCF 114 reassigns call session ports for the originating and terminating enterprise devices 414. At step 1060, any traffic received on the reassigned ports is automatically switched between the enterprise devices. The CGCF 114 may be otherwise suitably provision to switch their messages for the call session and/or determine that the call session is an intra enterprise session.

Still at step 1060, though traffic for the call session is switched locally, a network set up switch path at UNC 412, may be sustained to provide network surfaces for the call session. In this embodiment, the CGCF 114 may periodically send packets (from the call session or specifically generated) to the UNC 412 to ensure the call session is not terminated due to inactivity at the UNC 412. At step 1070, the call session is terminated. Upon termination, the switch path through the CGCF 114 and/or UNC 412 is torn down. Returning to step 1040, if the termination device is not local to the enterprise, the call is not an intra enterprise call and the no branch of step 1040 leads to step 1080. At step 1080, where messages for the call session are transmitted to the UNC 412 for switching to the termination device. Step 1080 also leads to step 1070 where the call session is terminated upon completion.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
receiving an initiation request for a call session including a mobile device;
generating an Internet Protocol (IP) message based, at least in part, on the initiation request, the IP message encapsulating a portion of a wireless-protocol request; and
transmitting the IP message including the encapsulated portion to a network element for tunneling the wireless protocol request through an IP network.

2. The method of claim 1, the initiation request comprising a wireless-protocol request, wherein generating an IP message comprises encapsulating at least a portion of the wireless-protocol request in the IP message.

3. The method of claim 2, the portion comprising a first portion, the method further comprising translating a second portion of the wireless protocol request to one or more headers of the IP message.

4. The method of claim 1, wherein IP message comprises a SIP-C message.

5. The method of claim 1, wherein the portion is encapsulated in a Multipurpose Internet Mail Extension (MIME) extension.

6. A method, comprising:
providing wireless services to a communication device through an IP network; and
wherein the communication device comprises an IP device.

7. The method of claim 6, wherein providing wireless services comprises representing to a network element the IP device as a wireless device including transmitting wireless protocol parameters to the network element.

8. The method of claim 6, wherein providing wireless services comprises tunneling wireless protocol messages through the IP network to provide wireless services to the IP device.

9. The method of claim 8, wherein the wireless protocol messages are encapsulated in IP messages.

10. The method of claim 6, wherein providing wireless services comprises translating between IP messages and wireless protocol messages to represent the IP device as a wireless device.

11. A system, comprising:
a wireline device operable to participate in a call session using a wireline protocol; and
a converter operable to convert between wireless protocol messages and wireline protocol messages to provide wireless services to the wireline device.

12. The system of claim 11, wherein the wireline device comprises an IP device.

13. The system of claim 11, wherein the wireless protocol message comprises Unlicensed Mobile Access (UMA).

14. The system of claim 11, wherein the wireline protocol messages comprises SIP-C.

15. The system of claim 11, wherein the converter operable to convert between wireless protocol messages and wireline protocol messages comprises the converter operable to convert wireline protocol parameters to wireless protocol parameters.

16. The system of claim 11, the wireless protocol messages comprises a first set of wireless protocol messages, the converter further operable to encapsulate at least a portion of wireless protocol messages in a second set of wireless protocol messages.

17. A communication session, comprising:
a session initiation protocol (SIP) packet; and
a portion of a wireless protocol message encapsulated in the IP packet.

18. The communication session of claim 17, the portion of the wireless protocol message comprising one or more SIP extensions including the portion of the wireless protocol message.

19. The communication session of claim 18, wherein the one or more SIP extensions comprises a MIME extension.

20. The communication session of claim 17, the portion of the wireless protocol message comprising a first portion, wherein the SIP packet includes headers translated from a second portion of the wireless protocol message.

21. A method comprising:
representing an IP network device as a wireless network device;
accessing one or more wireless network services through the IP network device; and
converting wireless protocol messages to SIP-C messages for communicating through the IP network.

22. The method of claim 21, further comprising:
receiving an IP message form the IP network device;
converting the IP message to at least a portion of a wireless protocol message; and
generating a SIP-C messages based, at least in part, on the portion of the wireless protocol message.
